(19) United States
(12) Patent Application Publication
(10) Pub. No.: US 2026/0171007 A1
(43) Pub. Date: Jun. 18, 2026

(54) METHOD AND APPARATUS FOR CONTROLLING A DISPLAY DEVICE HAVING IN-PIXEL MEMORY

(71) Applicant: SAPIEN SEMICONDUCTORS INC., Seongnam-si (KR)

(72) Inventors: Jun Young JUNG, Seongnam-si (KR); Myunghee LEE, Seongnam-si (KR); Jun Young JUNG, Seongnam-si (KR)

(21) Appl. No.: 19/409,543

(22) Filed: Dec. 4, 2025

(30) Foreign Application Priority Data
Dec. 18, 2024 (KR) 10-2024-0190103
Mar. 5, 2025 (KR) 10-2025-0027908

(51) Int. Cl. G09G 3/32

(52) U.S. Cl. CPC G09G 3/32; G09G 2300/0857; G09G 2310/08; G09G 2320/103; G09G 2330/021; G09G 2340/0435; G09G 2360/18

(57) ABSTRACT

A method and apparatus for low-power driving of a display device having in-pixel memory is provided. A display control method of a host device includes: generating display data; generating a synchronization signal for outputting the display data on a frame-by-frame basis; determining whether current frame data is identical to previous frame data for the frame data generated on the frame-by-frame basis; and transmitting, when the current frame data is identical to the previous frame data, a command indicating no change in frame data to a display module.

### CROSS-REFERENCE TO RELATED APPLICATION

This application claims priority to and the benefit of Korean Patent Application No. 10-2024-0190103, filed on Dec. 18, 2024, and Korean Patent Application No. 10-2025-0027908, filed on Mar. 5, 2025, in the Korean Intellectual Property Office, the disclosure of which is incorporated herein by reference.

### TECHNICAL FIELD

Example embodiments relate to a driving technology for display device, and more particularly, to a method and apparatus for enabling low-power driving based on data change detection in a display device having in-pixel memory. The disclosed technology is suitable for miniaturization in portable display devices such as smartphones, smartwatches, augmented reality (AR) devices, mixed reality (MR) devices, and extended reality (XR) devices, and relates to a method and apparatus capable of reducing power consumption and minimizing data transmission volume.

### BACKGROUND

Display devices can be applied across a wide range of applications, from compact mobile devices to large-scale outdoor signage. In particular, displays are increasingly being used in various fields such as in-vehicle systems, augmented reality (AR), mixed reality (MR), and extended reality (XR) devices.

Display systems are required to support high-resolution displays while also being compact and capable of low-power operation. However, in conventional display driving methods, even when there is no change in image data or when only a portion of the screen changes, the entire image frame is rewritten, stored, and scanned, which can lead to increased power consumption.

For example, in AR devices, applications that display simple information such as text or indicators are commonly used, and therefore, low-power driving through partial display control may be required.

Meanwhile, conventional display systems store frame data transmitted from a host processor (application processor, AP) in a frame memory inside a display driver integrated circuit (DDIC), and then output the data to the display panel. However, with the widespread use of high-resolution displays, the size of frame data has increased significantly, resulting in a substantial increase in the physical size and power consumption of the frame memory.

In particular, in ultra-compact display devices such as AR/MR/XR devices, the size of the frame memory can become a critical constraint in miniaturizing display driving circuits.

Additionally, as mobile devices become equipped with artificial intelligence (AI) functions, the processing load on the AP is increasing, and thus, an efficient method to reduce this burden is needed.

### BRIEF SUMMARY

An aspect of the present disclosure is to provide a method and a device capable of miniaturizing a driving circuit in a display device that requires ultra-compact and low-power driving through various embodiments.

Another aspect of the present disclosure is to provide a method and a device capable of minimizing image data traffic transmitted from a host device and reducing power consumption.

These aspects are merely illustrative and do not limit the scope of the present disclosure.

According to one embodiment of the present disclosure, a display control method of a host device comprises: generating display data; generating a synchronization signal for outputting the display data on a frame-by-frame basis; determining whether current frame data is identical to previous frame data for the frame data generated on the frame-by-frame basis; and transmitting, when the current frame data is identical to the previous frame data, a command indicating no change in frame data to a display module.

The command may be a Panel Self Refresh (PSR) command.

The command may be transmitted via an Embedded DisplayPort (eDP) protocol.

Each pixel of the display module may include an in-pixel memory.

The host device may determine whether the frame data has changed by comparing one or more of a hash value, a checksum, metadata, and a Cyclic Redundancy Check (CRC) value of the previous frame data and the current frame data.

According to another embodiment of the present disclosure, a display control method of a host device comprises: generating display data; generating a synchronization signal for outputting the display data on a frame-by-frame basis; determining whether current frame data is identical to previous frame data for the frame data generated on the frame-by-frame basis; and transmitting, when the current frame data is identical to the previous frame data, the synchronization signal excluding the frame data to a display module.

The synchronization signal may include a vertical synchronization signal (Vsync) and a horizontal synchronization signal (Hsync), and the display module may adjust timing of an internal synchronization signal based on the synchronization signal received from the host device.

According to yet another embodiment of the present disclosure, a display system comprises: an application processor (AP) configured to generate display data; a buffer memory configured to store the display data; and a display controller configured to generate a synchronization signal for outputting the display data on a frame-by-frame basis, wherein, when currently generated frame data is identical to previous frame data stored in the buffer memory, the display controller generates and transmits a command indicating no change in the frame data to a display module.

The display system may further comprise a display module configured to receive at least one of the frame data and the synchronization signal from the display controller and output the display data.

The display module may include a display panel comprising a plurality of pixels, each pixel may comprise an in-pixel memory configured to store, in multiple bits, pixel values of frame data corresponding to the respective pixel, and the display module does not require a frame memory configured to store the frame data.

According to still another embodiment of the present disclosure, a display system comprises: an application processor (AP) configured to generate display data; a buffer memory configured to store the display data; and a display controller configured to generate a synchronization signal for outputting the display data on a frame-by-frame basis, wherein, when currently generated frame data is identical to previous frame data stored in the buffer memory, the display controller transmits the synchronization signal excluding the frame data to a display module.

The display system may further comprise a display module configured to receive at least one of the frame data and the synchronization signal from the display controller and output the display data.

The display module may include a display panel comprising a plurality of pixels, each pixel may comprise an in-pixel memory configured to store, in multiple bits, pixel values of frame data corresponding to the respective pixel, and the display module does not require a frame memory configured to store the frame data.

According to an embodiment of the present disclosure, by storing frame data transmitted from a host device in an in-pixel memory of a display panel, a frame memory is not essentially required.

Accordingly, it is possible to achieve miniaturization and low power consumption of the driving circuit by eliminating the need for a frame memory.

In addition, image data traffic between the host and the display driving circuit can be minimized, and system processing speed can be improved.

Furthermore, by reducing overall system data traffic and power consumption, display efficiency can be enhanced.

Moreover, by minimizing the processing required for image handling and transmission, the operational load on the application processor (AP) can be reduced.

### BRIEF DESCRIPTION OF THE DRAWINGS

Embodiments will be described in more detail with regard to the figures, wherein like reference numerals refer to like parts throughout the various figures unless otherwise specified, and wherein:

FIG. 1 is a diagram illustrating an example of a display system according to related art.

FIG. 2 is a diagram illustrating an example of a display system according to an embodiment.

FIG. 3 is a diagram illustrating another example of a display system according to an embodiment.

FIG. 4 is a diagram illustrating an example of a display driving device according to an embodiment.

FIG. 5 is a diagram illustrating a configuration of a logic controller according to an embodiment.

FIG. 6 is a diagram illustrating an example of a method of operating a display device according to an embodiment.

FIGS. 7 and 8 are diagrams illustrating examples of a frame data comparison method according to an embodiment.

FIG. 9 is a diagram illustrating another example of a method of operating a display device according to an embodiment.

FIG. 10 is a diagram illustrating still another example of a method of operating a display device according to an embodiment.

FIGS. 11 and 12 are diagrams illustrating timing signals and display control based thereon according to an embodiment.

FIG. 13 is a diagram illustrating pixel operation of a display panel according to an embodiment.

FIG. 14 is a flowchart illustrating a display control method for low-power driving according to an embodiment.

FIGS. 15 and 16 are diagrams illustrating examples of a pixel driving circuit according to an embodiment.

FIG. 17 is a diagram illustrating yet another example of a display system according to an embodiment.

FIG. 18 is a flowchart illustrating a display control method based on regional comparison according to an embodiment.

FIG. 19 is a diagram illustrating an example of dividing a display panel into regions according to an embodiment.

FIG. 20 is a timing diagram illustrating signals for regional data update according to an embodiment.

FIG. 21 is a diagram illustrating another example of dividing a display panel into regions according to an embodiment.

FIG. 22 is a timing diagram illustrating signals for multiple regional data updates according to an embodiment.

### DETAILED DESCRIPTION OF THE DISCLOSURE

The structural or functional descriptions presented herein are merely illustrative examples for describing embodiments in accordance with the concept of the present disclosure. The embodiments in accordance with the concept of the present disclosure may be implemented in various forms and are not limited to the examples described in this specification.

Various modifications and numerous variations may be made to the embodiments of the present disclosure. Accordingly, the embodiments are illustrated in the drawings and described in detail in this specification. However, such illustration and description are not intended to limit the embodiments to the specific forms disclosed herein, but are intended to include all modifications, equivalents, and alternatives falling within the spirit and scope of the present disclosure.

Terms such as “first,” “second,” and the like may be used to describe various elements, but such elements should not be limited by these terms. These terms are used only to distinguish one element from another. For example, a first component could be termed a second component, and similarly, a second component could be termed a first component, without departing from the scope of the present disclosure.

When it is stated that one component is “connected” or “coupled” to another component, it should be understood that the component may be directly connected or coupled to the other component, or may be connected or coupled indirectly via one or more intervening components. In contrast, when a component is described as being “directly connected” or “directly coupled” to another component, it should be understood that there are no intervening components between them. Other terms describing relationships between components, such as “between” and “immediately between” or “adjacent to,” should be interpreted similarly.

The terminology used in this specification is intended to describe particular embodiments and is not intended to limit the scope of the present disclosure. Singular forms, as used herein, include plural forms as well unless the context clearly indicates otherwise. As used herein, the terms “comprises,” “includes,” or “has” specify the presence of stated features, numbers, steps, operations, elements, or combinations thereof, but do not preclude the presence or addition of one or more other features, numbers, steps, operations, elements, or combinations thereof.

Unless otherwise defined, all terms used herein, including technical or scientific terms, have the same meaning as commonly understood by one of ordinary skill in the art to which the present disclosure pertains. Terms generally defined in commonly used dictionaries should be interpreted as having a meaning consistent with their usage in the context of the relevant technical field and are not to be interpreted in an idealized or overly formal sense unless expressly so defined herein.

Hereinafter, embodiments will be described in detail with reference to the accompanying drawings. However, the scope of the present application is not limited or restricted by such embodiments. Like reference numerals are used to refer to like elements throughout the drawings. In this specification, the term “display device” may collectively refer to a display driver IC and a display panel.

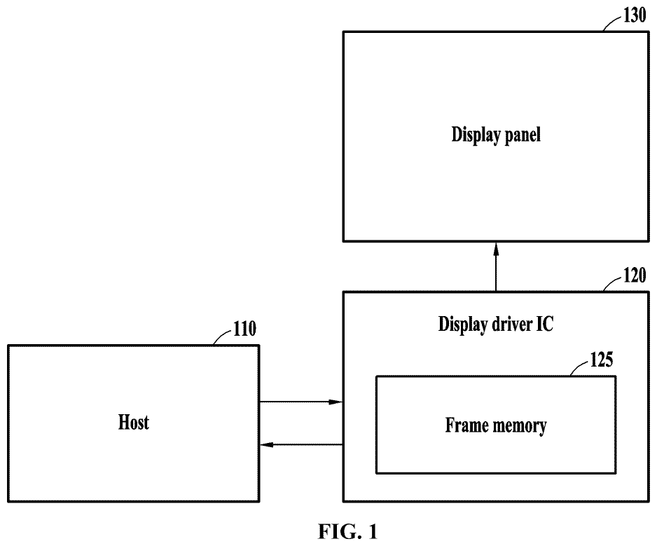

FIG. 1 is a diagram illustrating an example of a display system according to related art.

Referring to FIG. 1, the display system includes a host device 110, a display driver IC 120, and a display panel 130. The host device 110 may be implemented as a system on chip (SoC), an application processor (AP), or a mobile AP. The host device 110 may transmit frame data to the display driver IC 120.

Referring to FIG. 1, the display driver IC 120 includes a frame memory 125.

The frame memory 125 stores current frame data and is used during panel refresh. Accordingly, the structure according to related art essentially requires the frame memory 125.

However, in ultra-compact display environments, such as augmented reality (AR) devices, the frame memory 125 inside the display driver IC 120 may limit the active area and increase the size of control logic, making miniaturization difficult.

In addition, frequent refresh operations of the panel using the frame memory 125 may cause increased power consumption.

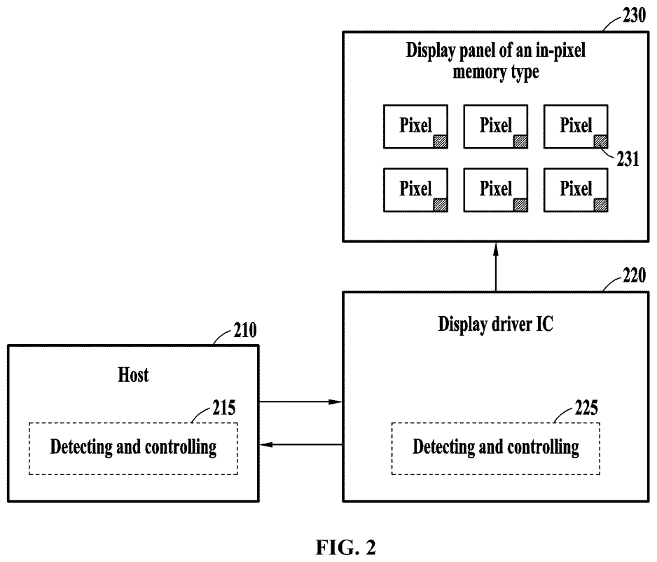

FIG. 2 is an example diagram illustrating a display system according to an embodiment of the present disclosure.

Referring to FIG. 2, a display system according to an embodiment includes a host device 210, a display driver IC 220, and a display panel 230 of an in-pixel memory type. Hereinafter, the term “display panel of an in-pixel memory type” may be simply referred to as a “display panel.”

In this disclosure, the term “display driver IC” may be referred to as “DDIC,” “backplane hardware logic,” “display driving device,” or “display controller.” In addition, the combination of the display driver IC and the display panel may be referred to as a “display device” or “display module.”

Unlike FIG. 1, the display system according to an embodiment may be configured to eliminate the frame memory and to utilize a digital in-pixel memory capable of storing 1-bit to 10-bit grayscale data.

The display system according to an embodiment has a structure in which the display driver IC 220 does not include a frame memory for storing frame data. Accordingly, the display driving device according to an embodiment may be designed to operate without a frame memory.

The host device 210 may include a processor and may execute firmware or software to support a video stream interface. The host device 210 may receive video images from various sources including Internet, and generate and transmit frame data to be displayed on a display screen to the display driver IC 220. The host device 210 may control the display driver IC 220. The host 210 may support a video stream interface.

The host device 210 or the display driver IC 220 may include detection and control blocks 215, 225 configured to detect, on a frame-by-frame basis, whether image data has been updated and to perform control operations accordingly.

When the host device 210 determines whether the frame data has been updated, the detection and control block 215 may perform an error check on the current frame F(t+1) based on the previous frame F(t).

Likewise, when the display driver IC 220 determines whether the frame data has been updated, the detection and control block 225 may perform an error check on the current frame F(t+1) based on the previous frame F(t). For example, the error checking may be performed using a parity check method, a checksum method, a cyclic redundancy check (CRC) method, a secure hash algorithm (SHA) method, or a Hamming code method.

The display panel 230 may be composed of a plurality of pixels, each of which includes a light-emitting element and a pixel circuit configured to drive the light-emitting element. Each pixel in the display panel 230 may include an embedded memory 231 capable of storing digital data.

The embedded memory 231 may be referred to as an “in-pixel memory.” The in-pixel memory may store image data and may be implemented using DRAM, SRAM, flip-flops, latches, or shift registers.

The display panel 230 may include a plurality of pixels arranged in various patterns, such as a matrix pattern or a zigzag pattern. Each pixel may emit a single color, for example, red, blue, green, or white, although other colors may also be emitted.

Each pixel may operate on a frame-by-frame basis. A single frame may consist of a plurality of subframes. Each subframe may include a data write period and a light emission period. During the data write period, a predetermined number of bits of digital data may be stored in the memory embedded in the pixel. During the light emission period, the stored digital data may be read in synchronization with a clock signal, and the digital data may be converted into a pulse-width modulation (PWM) signal to represent grayscale.

The light emission period of the subframe may be the sum of the durations assigned to each bit of the digital data.

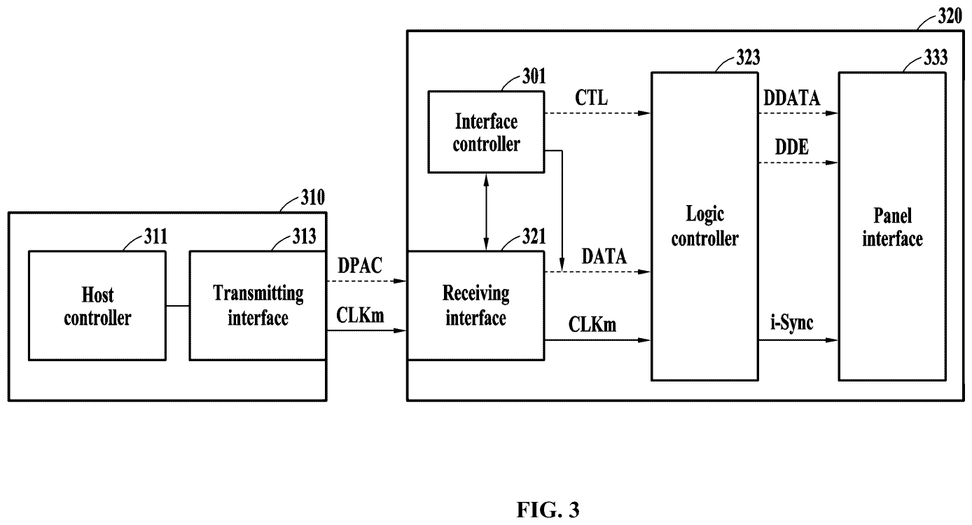

FIG. 3 is a diagram illustrating another example of a display system according to an embodiment.

The example illustrated in FIG. 3 shows a case in which the host 310 detects whether the frame data has been updated.

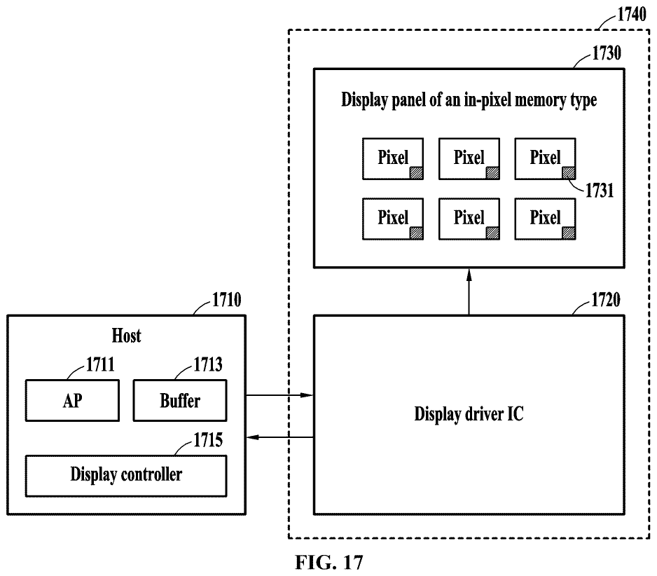

The host device 310 may include a host controller 311 and a transmitting interface 313. In another embodiment, as illustrated in FIG. 17, the host 310 may include an application processor (AP), an AP buffer, and a display controller.

The host controller 311 may include a processor and may execute firmware or software to support a video stream interface. The transmitting interface 313 may perform an interface function capable of supporting a video stream interface. The transmitting interface 313 may support MIPI, Embedded DisplayPort (eDP), or a high-speed serial interface.

The transmitting interface 313 may transmit image data, video data, and timing signals to a display driving device 320. The timing signals may include at least one of a vertical sync signal (Vsync), a horizontal sync signal (Hsync), a clock signal, and a data enable signal.

In FIG. 3, dashed arrows represent that the corresponding paths may not be used for their original purpose when there is no change in the data. For example, video stream transmission labeled as “DPAC” may not be performed if the frame data is not updated.

The display driving device 320 includes a receiving interface 321, an interface controller 301, and a logic controller 323. The display driving device 320 may further include a panel interface 333.

The receiving interface 321 may receive a video stream and timing signals transmitted from the host 310. In FIG. 3, the timing signal is indicated as “CLKm.” The timing signal may be a clock signal. Then, the receiving interface 321 may recover data (DATA) using the clock signal, and the clock signal may be bypassed to the logic controller 323.

The receiving interface 321 may receive a command (hereinafter simply referred to as “command”) from the host 310 indicating that there is no change in frame data.

The receiving interface 321 may also receive timing signals reflecting display location information corresponding to updated portions within the entire frame data. In this case, the receiving interface 321 may also receive frame data corresponding to the timing signals.

In one embodiment, the receiving interface 321 may recover a vertical sync signal (Vsync), a horizontal sync signal (Hsync), a data enable signal (DE), and data (DATA) from the video stream. The vertical sync signal and the horizontal sync signal may be received separately from the video stream. The clock signal may be bypassed to the logic controller 323, although this is not limiting. Here, the data enable signal (DE) is an indicator signal representing valid data: when the data enable signal is active, the data is valid; when inactive, the data is invalid.

The command may indicate that the current frame data is the same as the previous frame data. For example, the command may be a Panel Self Refresh (PSR) command. The command may be transmitted via an Embedded DisplayPort (eDP) protocol.

When the command is received by the receiving interface 321, the interface controller 301 may deactivate a frame data transmission path connected to the receiving interface 321. The frame data transmission path connected to the receiving interface 321 may include the path indicated as “DATA” in FIG. 3.

Upon receiving an indication of no change in frame data from the host 310, the receiving interface 321 may stop receiving the video stream and block the internal data transmission path within the display driving device 320. When there is no change in the frame data, the interface controller 301 may generate a control signal instructing to maintain an internal sync signal generated based on the previous frame data.

The control signal may be transmitted from the interface controller 301 to the logic controller 323. In FIG. 3, the control signal is represented as “CTL.” The path for transmitting the control signal is illustrated as a dashed line to indicate that this path is used only when there is no change in the frame data.

Upon receiving the control signal, the logic controller 323 may control the panel interface 333 and the display panel to refresh a screen based on an internal sync signal generated from the previous frame data and the previous frame data stored in the in-pixel memory. In FIG. 3, the internal sync signal is denoted as “i-Sync.”

The panel interface 333 may transmit video data, input during the enable section of the timing signals, to corresponding pixel locations within the display panel for writing.

When there is no change in the frame data, the panel interface 333 may transmit the internal sync signal, generated based on the previous frame data, to the display panel to refresh a screen using the previous frame data stored in the in-pixel memory.

The panel interface 333 may include a line buffer or a shift register. The panel interface 333 may write analog signals corresponding to display data and scan the written signals to transmit them to data lines provided in the display panel.

Referring to FIG. 3, the display driving device 320 has a structure that does not essentially include a frame memory for storing frame data.

In one embodiment, instead of transmitting a command indicating no frame data change, the host device 310 may transmit only a sync signal to the receiving interface 321 without transmitting frame data.

In such an embodiment, the receiving interface 321 receives the sync signal from the host device 310 without frame data. The interface controller 301 deactivates the frame data transmission path and generates a control signal to synchronize the existing internal sync signal with the sync signal received from the host device.

The generated control signal is delivered to the logic controller 323, which controls the panel interface 333 and the display panel to refresh the screen based on the updated internal sync signal and the previous frame data stored in the in-pixel memory.

In FIG. 3, the internal sync signal (i-Sync) is updated in synchronization with the received sync signal and is delivered to the display panel through the panel interface 333 to perform a screen refresh operation.

This method enables screen refresh without frame data transmission, thereby reducing unnecessary data transfer and lowering the data traffic between the application processor (AP) and the display driver IC (DDIC).

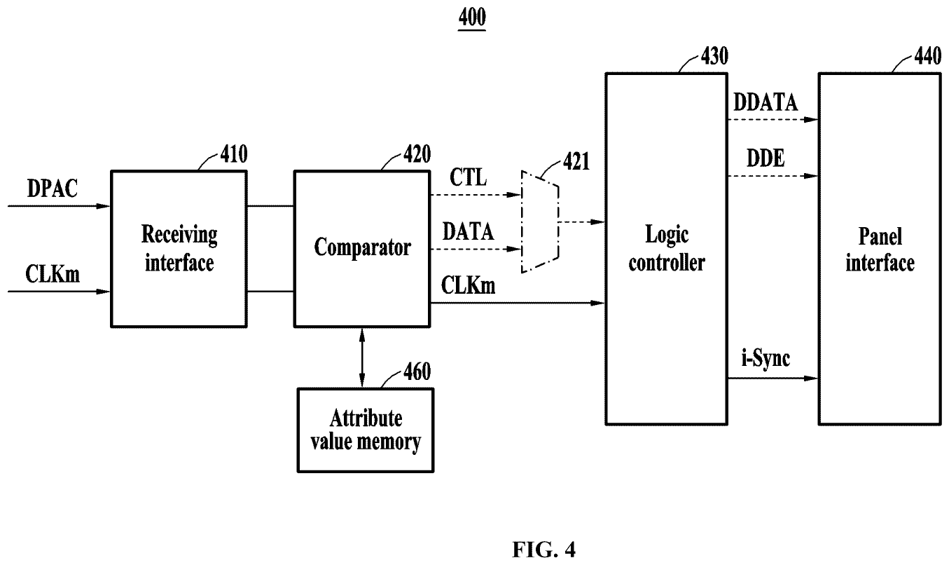

FIG. 4 is an example diagram illustrating a display driving device according to an embodiment of the present disclosure.

The example illustrated in FIG. 4 shows a case in which the display driving device 400 detects whether the frame data has been updated.

Referring to FIG. 4, the display driving device 400 includes a receiving interface 410, a comparator 420, and a logic controller 430. It may further include an attribute value memory 460, a path controller 421, and a panel interface 440.

The receiving interface 410 receives current frame data. The receiving interface 410 may receive a video stream and timing signals transmitted from the host device. In FIG. 4, the timing signal is represented as “CLKm.” The timing signal may be a clock signal.

The receiving interface 410 may recover data (DATA) using the clock signal, and the clock signal may be bypassed to the logic controller 430. In one embodiment, the receiving interface 410 may recover a vertical sync signal (Vsync), a horizontal sync signal (Hsync), a data enable signal (DE), and data (DATA) from the video stream. The vertical and horizontal sync signals may also be received separately from the video stream. The clock signal may be bypassed to the logic controller 430, although this is not limiting. Here, the data enable signal (DE) serves as an indicator signal for valid data: when the data enable signal is active, the data is valid; when inactive, the data is invalid.

The comparator 420 may compare an attribute value of the current frame data with an attribute value of the previous frame data to determine whether the frame data is the same. Here, the attribute value may be set as one of several data integrity check methods, such as a hash value, frame number, checksum, cyclic redundancy check (CRC), secure hash algorithm (SHA), or Hamming code.

When frame data is received, the comparator 420 may compute an attribute value and store the computed attribute value in the attribute value memory 460.

When the attribute value is a hash value, the comparator 420 may calculate a hash value for the current frame data and compare it with the hash value of the previous frame data to determine whether they are the same.

If the attribute value of the current frame data is the same as that of the previous frame data, the comparator 420 generates a control signal instructing deactivation of the frame data transmission path.

At this time, the comparator 420 may directly deliver the control signal to the logic controller 430 after blocking the frame data transmission path, or may transmit the control signal to the path controller 421.

In FIG. 4, the control signal is denoted as “CTL.” In this case, screen refresh of the display panel is performed using the previous frame data stored in the in-pixel memory.

If the attribute value of the current frame data is different from that of the previous frame data, the comparator 420 may instruct the path controller 421 to maintain the frame data transmission. In such a case, the comparator 420 may transmit the newly received frame data from the receiving interface 410 to the logic controller 430, and the display panel may write the new frame data into the in-pixel memory and perform screen refresh based on it.

Upon receiving the control signal, the logic controller 430 controls the panel interface 440 and the display panel to refresh the screen using the previous frame data stored in the in-pixel memory.

The attribute value memory 460 stores attribute values corresponding to frame data. The attribute value may be updated and stored for each frame. The attribute value memory 460 may be implemented using SRAM, flip-flops, latches, or shift registers.

When the path controller 421 receives the control signal, it may block the frame data transmission path to prevent unnecessary data transfer and reduce power consumption.

When the frame data has changed, the path controller 421 may control the path such that the currently received frame data is output to the logic controller 430. Alternatively, the frame data may be directly transferred from the comparator 420 to the logic controller 430.

The panel interface 440 may transmit video data, input during the enable period of the timing signal, to the corresponding pixel locations within the display panel for writing.

In one embodiment, the comparator 420 may be configured to be activated only when the system operates in a low power mode.

When the system is not in a low power mode, the receiving interface 410 may be directly connected to the logic controller 430. In this embodiment, upon receiving a low power mode command from the host device, the receiving interface 410 may activate the comparator 420.

Upon receiving the low power mode command, the comparator 420 may be activated to perform a comparison operation, in which the attribute value of the current frame data is compared with that of the previous frame data.

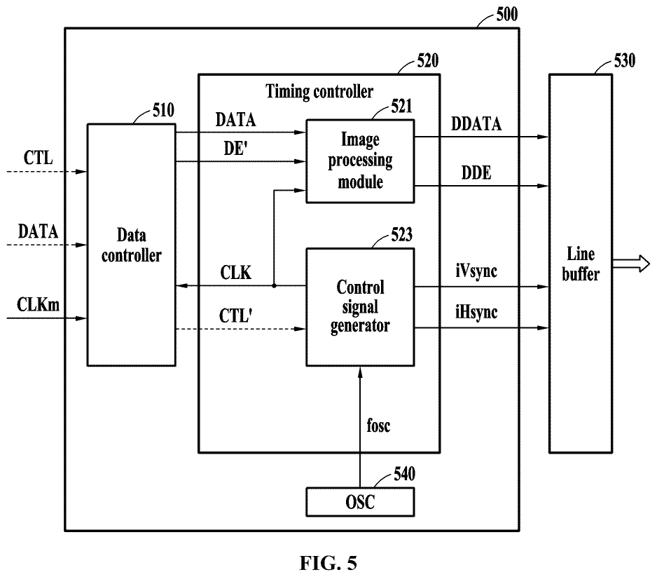

FIG. 5 is an example diagram illustrating a configuration of a logic controller according to an embodiment of the present disclosure.

Referring to FIG. 5, the logic controller 500 may include a data controller 510 and a timing controller 520. The line buffer 530 shown in FIG. 5 may correspond to the panel interface 333, 440 illustrated in FIG. 3 or FIG. 4.

First, the operation of the logic controller 500 is described for the case in which frame data is changed, followed by the operation for the case in which frame data is not changed.

### When Frame Data Is Changed: Normal Operation Mode

The data controller 510 may generate a data enable signal (DE′) using an internal clock signal (CLK) and may transmit the data enable signal (DE′) and data (DATA) to the timing controller 520. The data enable signal (DE′) may serve as an indicator signal that defines the valid period of the data (DATA).

An oscillator 540 generates an internal clock signal (fosc). The timing controller 520 may generate signals such as a clock (CLK), an internal vertical sync signal (iVsync), and an internal horizontal sync signal (iHsync) based on the internal clock signal (fosc).

The timing controller 520 may include a control signal generator 523 and an image processing module 521. In one example, the control signal generator 523 may generate the clock signal (CLK) based on the internal clock (fosc). The clock signal (CLK) may be generated using the internal clock (fosc), and the frequency of the clock signal (CLK) may be the same as or different from that of the internal clock (fosc).

In another example, the control signal generator 523 may further generate the internal vertical sync signal (iVsync) and the internal horizontal sync signal (iHsync) based on the internal clock (fosc).

The internal vertical sync signal (iVsync) may correspond to the vertical synchronization associated with the display of display data (DDATA), and the internal horizontal sync signal (iHsync) may correspond to the horizontal synchronization associated with the display of display data (DDATA).

The image processing module 521 may receive the clock (CLK), the data enable signal (DE′), and data (DATA), and may process read data (DATA) using the clock (CLK) and the data enable signal (DE′). As a result of the processing, the image processing module 521 may generate a data enable signal (DDE) and display data (DDATA). Here, the display data DDATA refers to n-bit data (where n≥2) corresponding to pixel values for each pixel of the display panel. The data enable signal (DDE) may serve as an indicator signal that defines the valid period of the display data (DDATA).

For example, the image processing module 521 may perform an image enhancement function and/or an image editing function. Specifically, the image processing module 521 may adjust brightness, contrast, saturation, or sharpness of the data (DATA), and generate display data (DDATA) corresponding to the adjusted results.

The line buffer 530 or shift register may receive the data enable signal (DDE) and the display data (DDATA), and may transmit corresponding signals to the display panel. For example, the line buffer 530 may write analog signals corresponding to the display data (DDATA), and scan the written signals to transmit them to data lines arranged in the display panel.

More specifically, the line buffer 530 may write the data (DDATA) in response to the clock (CLK) and the periodically activated data enable signal (DDE). Even more specifically, the line buffer 530 may write the data (DDATA) when the data enable signal (DDE) is active or turned on.

In one example, the line buffer 530 may perform a scanning operation in response to the internal vertical sync signal (iVsync) and the internal horizontal sync signal (iHsync).

The scanning operation refers to the process in which the line buffer 530 reads the data (DATA) and transmits the read data (DATA) to the display panel.

The line buffer 530 may write the data (DDATA). Specifically, the line buffer 530 may write the data (DATA) each time the data enable signal (DDE) is activated.

The line buffer 530 may scan the stored data (DATA) in response to the internal horizontal sync signal (iHsync) and transmit it to the display panel. More specifically, each time the internal horizontal sync signal (iHsync) is deactivated, the line buffer 530 may read and scan the written data and transmit it to the display panel 400. The display panel may then write the data into the memory within each pixel.

The display panel may read and display the data (DATA) stored in the in-pixel memory in response to the internal horizontal sync signal (iHsync). Specifically, each time the internal horizontal sync signal (iHsync) is activated, the display panel may display the written data.

### When Frame Data Is Not Changed: Low Power Operation Mode

When the previous frame data and the currently received frame data are determined to be the same, the data controller 510 and the image processing module 521 may stop operating or perform only partial operations. Accordingly, the internal frame data transmission path within the display driving device may be blocked, and power consumption may be reduced. For example, the frame data transmission path may include the paths indicated as “DATA” and “DDATA” in FIG. 5.

Upon receiving a control signal (e.g., CTL′) instructing to maintain the sync signal of the previous frame, the control signal generator 523 may refrain from generating a new internal sync signal and may output the previously used sync signal to the line buffer 530.

In addition, the logic controller 500 may enter a low power mode after receiving a command indicating no change in frame data and may transmit an interrupt signal to the host device to check for frame data transmission after a predetermined time has elapsed. For example, the interrupt signal may be transmitted to the host after a preset number of self-refresh operations or after a predetermined time duration.

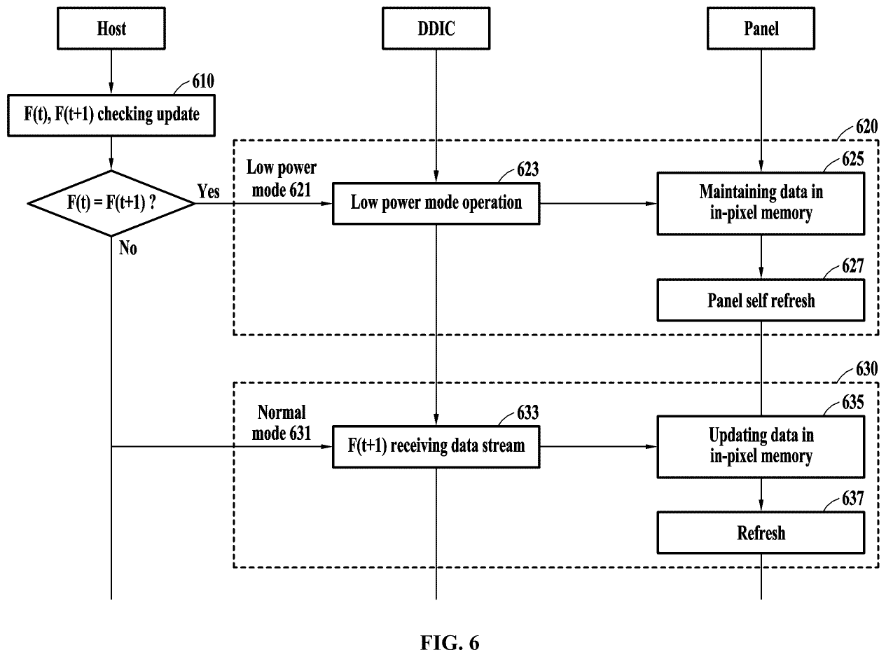

FIG. 6 illustrates an example of an operation method of a display device according to an embodiment of the present disclosure. The method illustrated in FIG. 6 may be performed by the system shown in FIG. 3.

Referring to FIG. 6, in step 610, the host device checks whether the frame data is updated by performing an error check on the current frame F(t+1) based on the data of the previous frame F(t).

As described above, the update check of the current frame compared to the previous frame may be performed by comparing an attribute value of the current frame data F(t+1) with an attribute value of the previous frame data F(t) to determine whether the frame data is the same.

The attribute value may be one of data integrity verification schemes such as a hash value, a frame number, a checksum, a cyclic redundancy check (CRC), a secure hash algorithm (SHA), or a Hamming code.

If F(t) and F(t+1) are determined to be the same, then in step 620, a low power mode is performed. Otherwise, in step 630, a normal operation mode is executed.

In step 621, the display driver IC (DDIC) may receive a signal from the host device indicating the low power mode.

The signal indicating the low power mode may be any one of: a command indicating that the current frame data is the same as the previous frame data, a predefined low power mode entry command, or a sync signal received without any frame data.

In step 623, upon receiving the signal indicating the low power mode, the DDIC performs a low power mode operation. For example, when the DDIC receives a PSR command, the DDIC may deactivate a frame data transmission path and maintain an internal sync signal generated based on previous frame data. In this case, deactivating the frame data transmission path may include disabling reception of frame data from the host device and stopping internal data transmission within the display driver IC, excluding control signals for generating a sync signal.

The display panel performs a display operation based on the internal sync signal and the previous frame data stored in the in-pixel memory. For example, in step 625, the display panel may maintain the previous frame data stored in the in-pixel memory, and in step 627, may perform panel self-refresh.

Additionally, when the DDIC receives a sync signal from the host device without frame data, the DDIC may deactivate the frame data transmission path and update the internal sync signal generated based on the previous frame data. For example, the DDIC may synchronize the internal sync signal with the sync signal received from the host device. For example, the DDIC may generate the internal sync signal in synchronization with the MIPI signal, based on a clock generated by an internal oscillator.

In this case, the display panel may refresh the screen based on the updated internal sync signal and the previous frame data stored in the in-pixel memory.

For example, “synchronizing the internal sync signal” may include adjusting timing of the internal sync signal based on the sync signal received from the host device. It may also include detecting a phase of the host sync signal and adjusting a phase of the internal sync signal accordingly. Further, it may include measuring a frequency of the host sync signal and compensating the frequency of the internal sync signal based on the measured frequency. In addition, the internal sync signal may be initialized for synchronization whenever a specific sync signal event is received from the host.

Meanwhile, when the DDIC receives a sync signal from the host during a current frame data transmission period, the DDIC may determine whether frame data is received, and if the frame data is not received within a predetermined time, the DDIC may determine that the sync signal is received without the frame data. The sync signal received from the host device may include a vertical sync signal (Vsync) and a horizontal sync signal (Hsync).

In the normal mode of step 630, the host device may or may not transmit an indication to the DDIC indicating that the system is operating in the normal mode. In step 633, the DDIC receives a data stream of the current frame F(t+1) from the host. In step 635, the display panel updates the data in the in-pixel memory, and in step 637, refreshes the screen.

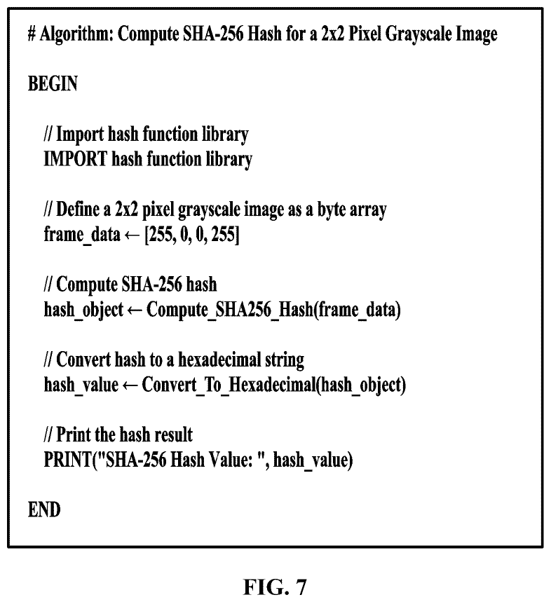

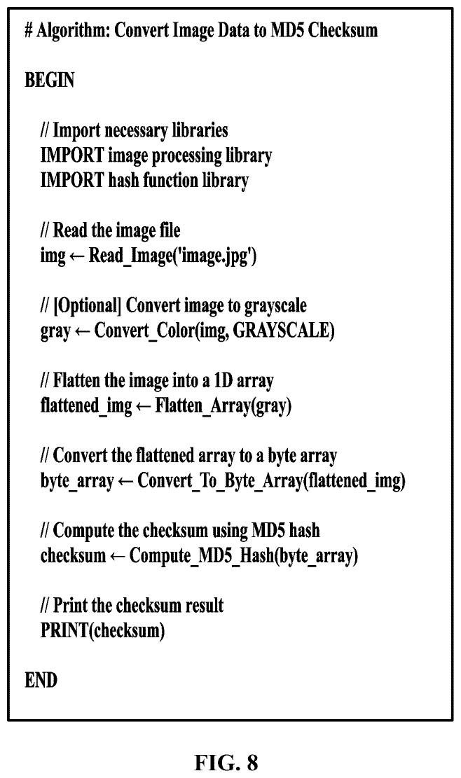

FIGS. 7 and 8 are example diagrams illustrating a frame data comparison method according to an embodiment of the present disclosure.

A host processor may utilize a hash comparison method to determine whether a new frame's data (new frame data) is identical to a previous frame's data (previous frame data). First, before processing the new frame data, the host processor calculates a hash value of the corresponding image. A hash function converts the image into a unique string, and the same hash value is generated for identical images. When new frame data arrives, the host processor calculates the hash value of the corresponding image and compares it with the hash value of the previous frame data. If the hash values are identical, it is determined that the image has not changed, and data transmission is omitted, while the previous frame data is retained. In contrast, if the hash values differ, the new frame data is transmitted to update the display.

FIG. 7 illustrates an example of pseudo-code for generating a hash value of a 2×2 pixel grayscale image. Referring to FIG. 7, the process of generating a SHA-256 hash value using each pixel value of a 2×2 image in which the first row is [255, 0] and the second row is [0, 255] is shown.

FIG. 8 illustrates an example of calculating a hash value using an example image processing library.

Referring to FIG. 8, the process of generating a hash value includes receiving image data, converting the image data into a one-dimensional byte array, and applying a hash function to generate a fixed-length hash value. In general, in addition to comparing the entire image data, a partial image comparison may also be performed. For instance, when only a specific region is to be compared, checksum calculation may be performed using only the data corresponding to that region. To enhance the accuracy of image comparison, preprocessing methods such as noise removal and image resizing may be applied to normalize the image.

In the process of generating a hash value from image data, image processing libraries such as OpenCV (Open Source Computer Vision Library) or PIL (Python Imaging Library) may be utilized. For example, OpenCV may be used to convert the image into grayscale to reduce color information, convert it into a one-dimensional array, and then apply a hash function. This method is more efficient than directly comparing all the image data and is suitable for rapidly determining whether two images are identical.

As described above, a comparison method using hash values is effective in maintaining the accuracy of data comparison while minimizing computation load and reducing unnecessary data transmission. In particular, this method supports fast and reliable identity verification in environments where large volumes of digital images are processed, and it may be applied in a display system to detect changes in frame data and prevent unnecessary frame updates.

To generate hash values, an appropriate hash function should be selected. Commonly used hash functions include MD5, SHA-1, SHA-256, and SHA-512, and an appropriate function may be selected according to the intended purpose.

When the host processor determines that the frame data has not changed, it may notify the display driving device to prevent unnecessary data transmission. Methods for such notification may include transmitting a special control signal or utilizing a frame number and timestamp.

In the method of transmitting a special control signal, the host processor may utilize a PSR (Panel Self Refresh) command (e.g., eDP v1.5) to notify the display driving device that the current image is identical to the previous image. The host processor generates a specific control signal indicating that the current frame is the same as the previous frame, and transmits the control signal to the display driving device. Upon receiving the control signal, the display driving device may refrain from receiving new frame data and instead refresh the screen using the previously stored frame data. For example, control commands such as “Frame Hold,” “No Data Update,” or “Skip Frame Transmission” may be used. By applying a PSR command, the display driving device may autonomously perform screen refreshing, thereby reducing unnecessary power consumption.

In PSR mode, the display panel may maintain frame synchronization without requiring Vsync and Hsync signals. This is because the screen is refreshed using frame data stored in the panel's internal memory, which also contributes to further reducing power consumption by eliminating the need for transmitting synchronization signals.

Frame synchronization in PSR mode may be maintained through various methods. First, an internal timer may be used. The panel may utilize a built-in timer to refresh the screen at a constant interval, thereby performing consistent screen refresh even in the absence of Vsync and Hsync signals.

Second, a frame buffer-based method may be used. The panel may refresh the screen using frame data stored in the internal frame buffer. When displaying a static image, consistent screen output may be provided without dynamic updates or external synchronization signals.

Third, a CRC (Cyclic Redundancy Check)-based integrity verification method may be used. The panel may periodically perform CRC checks to verify the integrity of the stored frame data, ensuring that the data has not changed. This allows the panel to maintain image consistency even in PSR mode and to prevent unintended data corruption.

Through these techniques, stable frame synchronization may be maintained even in PSR (Panel Self Refresh) mode, thereby maximizing power efficiency compared to conventional synchronization signal-based methods.

The PSR command is defined in the eDP (Embedded DisplayPort) standard and is transmitted to the panel through a specific packet structure. The packet structure of the PSR command may include the following elements:

Packet Header: indicates the start of the packet and includes information such as packet type and length.

Command Code: identifies the PSR command so that the display driving device can interpret and execute it.

Data Field: contains specific data for controlling PSR functions, such as PSR enable/disable status, PSR mode transition conditions, and current PSR state information.

Checksum: ensures data integrity and verifies whether transmission errors have occurred during packet delivery.

The host processor may also recognize the same image based on frame numbers or timestamps. The display driving device may determine that frame data has not changed by comparing the received frame number or timestamp with the previously stored value, and continue to use the existing frame data. For example, if the new frame is identical to the previous one, the host processor may transmit the same timestamp as that of the previous frame to indicate that no update has occurred. If the received frame number is identical to the previous frame, the display driving device may skip transmission of new frame data and retain the previously stored data.

When the host determines that the image has not changed and controls the display driving device to refrain from transmitting new frame data, unnecessary data traffic between the application processor (AP) and the display driver IC (DDIC) can be reduced. Furthermore, this approach may reduce redundant operations within the display driving device, enable low-power operation, and minimize overall power consumption. Such an implementation is particularly advantageous in environments where power efficiency is critical, such as in mobile and wearable devices.

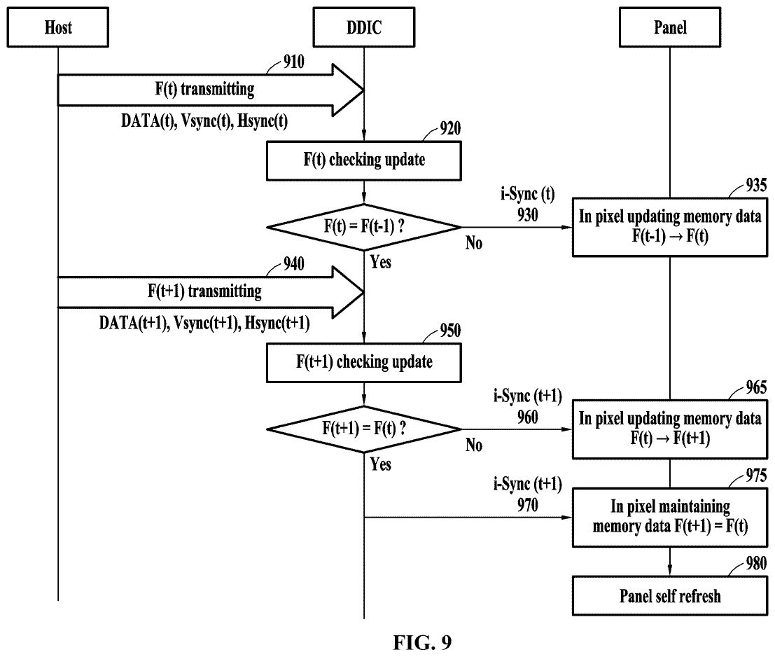

FIG. 9 is another example diagram illustrating a method for operating a display device according to an embodiment.

The method illustrated in FIG. 9 may be performed by the system shown in FIG. 4.

Referring to FIG. 9, in operation 910, the display driver IC (DDIC) receives current frame data F(t) from the host.

In operation 920, the DDIC compares the previous frame data F(t−1) with F(t) to check for an update.

If F(t−1) and F(t) are not identical, then in operation 930, the data and synchronization signal are transmitted to the display panel, and in operation 935, the data stored in the pixel-embedded memory may be updated.

In operation 940, the DDIC receives the next frame data F(t+1), and in operation 950, checks whether the frame data is updated.

At this time, the DDIC compares an attribute value of the frame data F(t+1) with that of F(t).

If the attribute value is a hash value, the DDIC may calculate the hash value of the current frame data F(t+1) and compare it with the hash value of the previous frame data F(t).

If the attribute value is a frame number or metadata, the attribute value of the current frame data may be received from the host, and the DDIC may determine whether the data are identical by comparing the frame number or metadata of the current and previous frame data.

If the attribute value of F(t+1) differs from that of F(t), then in operation 960, the data and synchronization signal are transmitted to the display panel, and in operation 965, the pixel-embedded memory may be updated.

If the attribute value of F(t+1) is identical to that of F(t), the frame data transmission path is deactivated, and in operation 970, only the synchronization signal iSync(t+1) is transmitted to the display panel.

In operation 975, the data in the pixel-embedded memory is maintained as the previously stored frame data F(t).

Then, in operation 980, the screen may be refreshed based on the previous frame data F(t) stored in the pixel-embedded memory.

If the attribute value of F(t+1) is identical to that of F(t), the DDIC may enter a low power mode.

For example, if frame data from F(t+1) to F(t+s) (where s is an integer greater than 10) are continuously identical, the DDIC may operate in the low power mode.

In the low power mode, the DDIC may block reception of frame data for a preset period of time.

Once the preset time elapses, the DDIC may transmit an interrupt signal to the host to check whether frame data transmission should resume.

Upon detecting the interrupt signal, the host may restart the transmission of frame data.

Meanwhile, regardless of whether the attribute value of the current frame data is identical to that of the previous frame data, the internal synchronization signal generated from the previous frame data may be updated based on the synchronization signal included in the current frame data.

The update of the internal synchronization signal may include adjusting the timing of the internal synchronization signal with reference to the synchronization signal received from the host.

The display driver IC (DDIC) may maintain the internal synchronization signal while displaying the previous frame data on the screen.

The synchronization signal and the data signal may operate independently, and the synchronization signal may continue to be generated even when the data is not transmitted.

The display driving circuit may update the screen based on the synchronization signal. For example, when the display driving circuit needs to continue displaying the same image, the host processor may transmit a control signal indicating “no change,” and the display driving circuit may recognize that the data has not been updated.

After that, the synchronization signal may continue to be transmitted from the host to the DDIC, and the screen may be refreshed while maintaining the previous data.

In this case, only the Vsync (vertical synchronization signal) and Hsync (horizontal synchronization signal) may be transmitted to the DDIC to continuously maintain the synchronization signal.

The DDIC may internally generate an i-Vsync (internal vertical synchronization signal), and the data bits stored in the in-pixel memory may be maintained as they are.

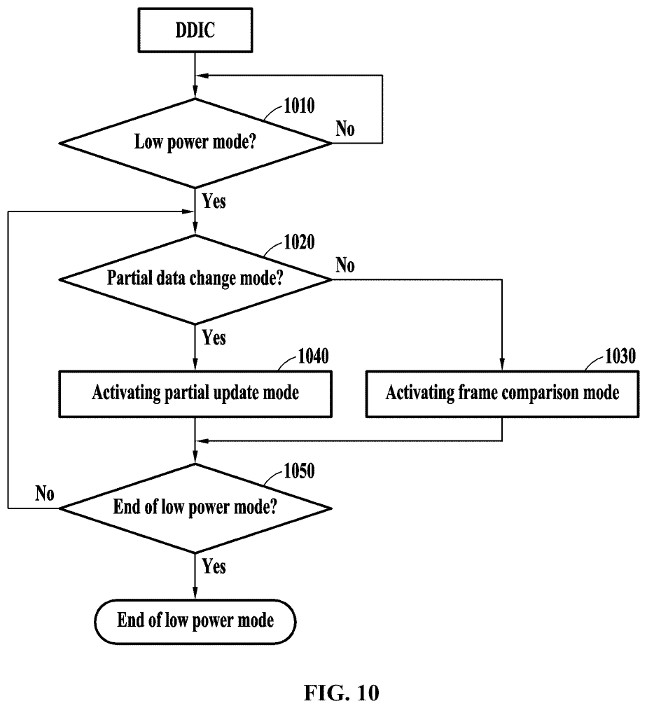

FIG. 10 illustrates another example of an operation method of a display device according to an embodiment.

Referring to FIG. 10, the display driver IC (DDIC) periodically checks, in step 1010, whether a low power mode command is received, and enters a low power operation mode when the low power mode command is received from the host.

Subsequently, the DDIC determines whether it is in a partial data update mode or a frame comparison mode, in step 1020. Whether the DDIC is in the partial data update mode or the frame comparison mode may be determined based on a command or instruction received from the host.

The DDIC receives information from the host indicating either no change in the entire frame data or a partial data update, and may update the screen according to the received information.

For example, when the DDIC receives an indication from the host that there is no change in the entire frame data, the frame comparison mode may be activated in step 1030. The frame comparison mode may be implemented using the method described with reference to FIG. 9.

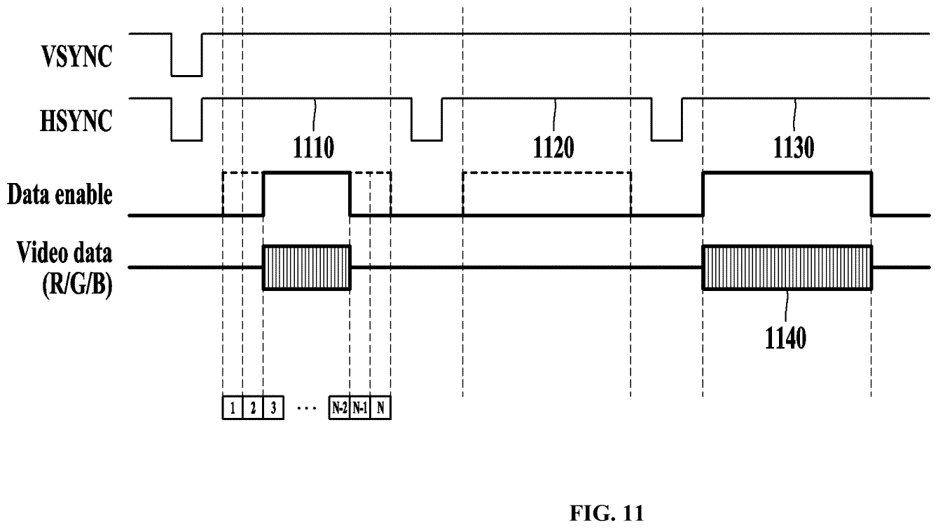

For example, when the DDIC receives an instruction from the host indicating a partial data update, a partial update mode may be activated in step 1040. A specific example of the partial update mode will be described with reference to FIGS. 11 to 14.

The information indicating the partial data update may include image data of the updated region and location information corresponding to the updated region. The updated image data may be written to the in-pixel memory corresponding to the location information, and the screen may be refreshed based on the data stored in the in-pixel memory.

The DDIC may determine, in step 1050, whether to exit the low power mode based on communication with the host.

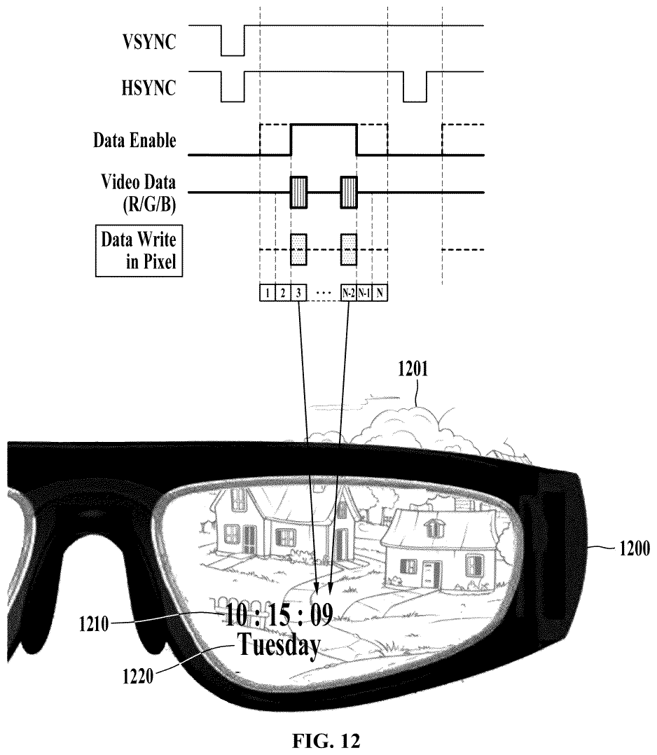

FIGS. 11 and 12 illustrate example timing signals and display control according to an embodiment of the present disclosure.

When transmitting data to the display driver IC (DDIC), the host may transmit only partial image data of a changed region instead of transmitting the entire frame data. For example, in a frame image consisting of a background and text, when only the text is changed, the host may transmit only the image data corresponding to the text, without transmitting the image data corresponding to the background. This can reduce unnecessary data transmission and lower system power consumption and data processing load.

The host may determine the partial image data through frame data comparison or identification of a region of interest.

Referring to FIG. 11, the HSYNC and Data Enable signals may be timing signals in which display position information requiring an update in the entire frame is reflected. In this case, the display panel may include a first line 1110, a second line 1120, and a third line 1130. Each line may include pixels 1, 2, 3, . . . , N-2, N-1, and N.

The logic controller of the display control device may determine the row information of the display position based on the horizontal synchronization signal included in the timing signal.

From the perspective of the display panel, the display positions requiring updates are the first line 1110 and the third line 1130. The logic controller of the display control device may determine column information based on a counted time from the end of a porch section to the enable section of the timing signal.

For example, the logic controller may determine pixels 1 and 2 of the first line 1110 as “non-update” pixels based on the counted time from the end of the porch section to the start of the Data Enable section. In addition, based on the counted time from the start of the Data Enable section, the logic controller may determine that pixels 3 to N-2 of the first line 1110 are to be updated.

The logic controller may generate update bits indicating whether to update display pixels corresponding to row and column information based on the Data Enable signal. For convenience of explanation, it is described as “determining column information based on the counted time to the enable section of the timing signal,” but in practice, the logic controller may determine the update status on a per-pixel basis.

For example, the logic controller may generate an update bit ‘0’ for pixel 1 and transmit the update bit to the display panel. Likewise, the logic controller may generate and transmit an update bit ‘0’ for pixel 2, while generating and transmitting update bits ‘1’ for pixel 3 and pixel N-2 to the display panel. On the other hand, the logic controller may generate and transmit update bits ‘0’ for pixel N-1 and pixel N.

Referring to FIG. 11, the Data Enable signal corresponding to the third line 1130 indicates that all pixels are in the enabled state. Accordingly, the update bits for each pixel in the third line 1130 may be set to ‘1’, and the video data 1140 to be input to the third line 1130 may be provided to each corresponding pixel.

Meanwhile, the ON period of the Data Enable signal does not necessarily coincide with the video data input period. Referring to FIG. 12, it can be seen that in some embodiments, even during the enabled section of the Data Enable signal, video data may be input only to selected pixels.

Therefore, the logic controller may determine whether each pixel requires an update by checking the input of the video data together with the timing signal. The logic controller may determine the pixel positions that require updating based on at least one of the ON section of the Data Enable signal or the video data input section, according to a predefined protocol with the host.

The example illustrated in FIG. 12 corresponds to a case in which only some pixels are updated. For example, among pixels 1 through N, only pixel 3 and pixel N-2 may be updated. The logic controller may generate an update bit ‘1’ for pixel 3 corresponding to the section where video data is input during the enabled section of the Data Enable signal, and transmit the update bit to the display panel. Likewise, the logic controller may generate and transmit an update bit ‘1’ for pixel N-2 using the same method.

Referring to FIG. 12, the figure also illustrates the user's view of a real-world scene 1201 through smart glasses 1200. In this case, text information 1210 and 1220 may be provided in a portion of the display area of the smart glasses 1200 to deliver augmented reality information.

Accordingly, partial updates may be applied to the regions in which the text information 1210 and 1220 is displayed. For example, the first text information 1210 may represent time information including a second hand. The region where the second hand is displayed may require more frequent data updates than other regions, and data updates may be controlled on a per-pixel basis in such a case.

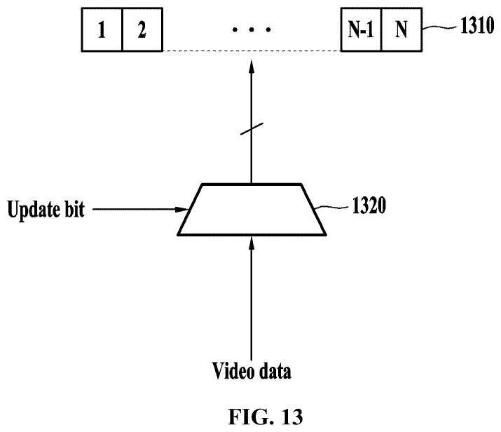

FIG. 13 illustrates pixel operations of a display panel according to an embodiment.

Referring to FIG. 13, each pixel may include an in-pixel memory 1310 and a path controller 1320. The in-pixel memory 1310 may store m-bit video data applied via a column line or a panel interface during a data writing period. The in-pixel memory 1310 may store at least one bit of data and may be implemented with fewer than m bits depending on the driving frequency.

The in-pixel memory 1310 may include a shift register. The in-pixel memory 1310 may be implemented using one or more transistors, and may be realized as a type of random access memory (RAM), such as SRAM or DRAM.

The in-pixel memory 1310 may be reset and updated with video data when video data is applied via the path controller 1320.

The path controller 1320 may function as a comparator, a switch, or a multiplexer. The path controller 1320 may receive an update bit and, when the update bit is ‘0’, may not deliver the video data to the in-pixel memory 1310. In this case, no video data may be input from the host device.

Accordingly, when the update bit is ‘0’, the path controller 1320 may not perform any path control operation but may simply deliver a signal to the in-pixel memory 1310 to indicate that data is being maintained.

When the update bit is ‘1’, the path controller 1320 may deliver the video data to the in-pixel memory 1310.

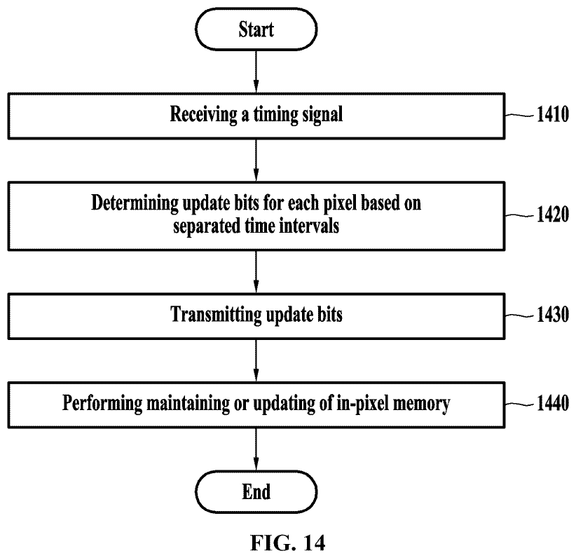

FIG. 14 is a flowchart illustrating a display control method for low-power driving according to an embodiment.

Referring to FIG. 14, in step 1410, the display control device receives a timing signal from a host, the timing signal including display position information indicating updated regions in the entire frame data.

In step 1420, the display control device identifies a preset porch interval and an enable section of the timing signal, and determines display positions corresponding to the enable section. The process of determining display positions may include determining row information based on a horizontal synchronization signal included in the timing signal, and determining column information based on a counted time from the end of the porch interval to the start of the enable section of the timing signal.

The display position information requiring an update may include information for a preset zone of the display panel, line-specific information, or pixel-specific information of the display panel. For example, the Data Enable signal may reflect timing signal information for updating a preset region. Accordingly, the Data Enable signal may be turned on or activated in correspondence to the preset region.

In addition, in step 1420, the display control device may determine update bits for each pixel of the display panel at different time intervals based on logical low or high levels of the timing signal. The logical low or high levels of the timing signal may correspond to the on or off periods of the Data Enable signal as shown in FIGS. 12 to 14.

In step 1430, the display control device transmits the determined update bits to the display panel. For example, a panel interface may transmit the update bits line-by-line or pixel-by-pixel to the display panel.

In step 1440, the display panel performs maintaining or updating of the in-pixel memory on a line or pixel basis, based on the update bits.

In other words, in step 1440, the display panel may write video data, received during the enable section of the timing signal, into the in-pixel memory of the pixels corresponding to the display positions that require updates. The writing operation may include controlling the update of in-pixel memory line-by-line based on the row information. Furthermore, the writing operation may include generating an update bit indicating whether a pixel corresponding to the row and column information should be updated, and updating the in-pixel memory or retaining previously stored data based on the update bit.

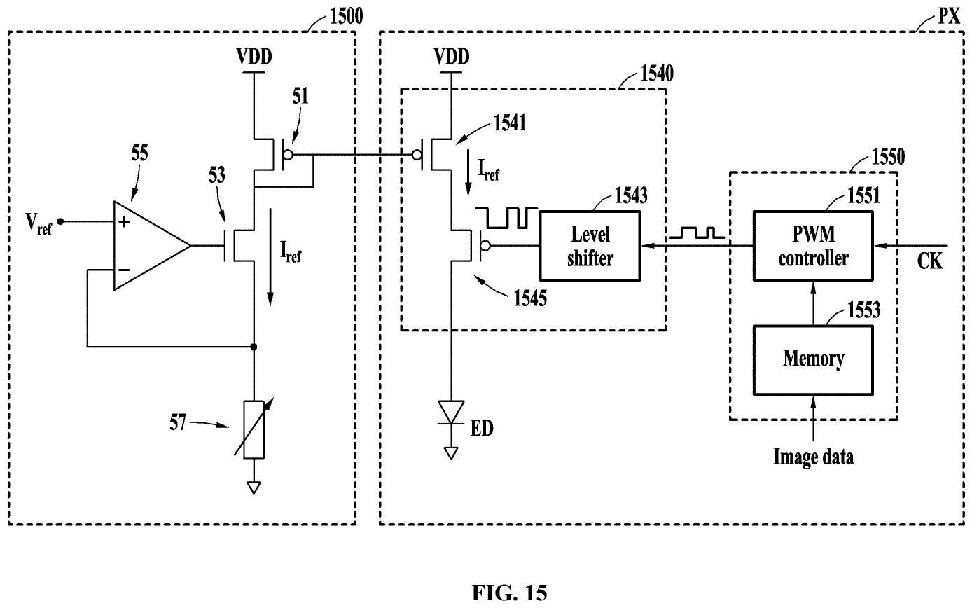

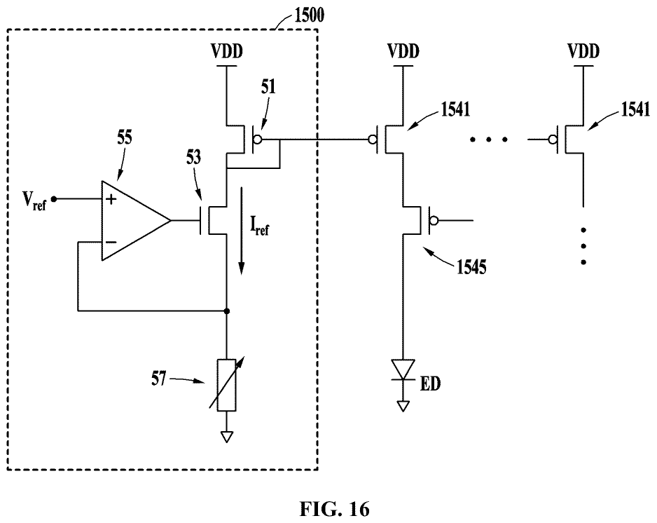

FIGS. 15 and 16 are diagrams illustrating examples of a pixel driving circuit according to an embodiment.

Referring to FIG. 15, a pixel (PX) may include a pixel circuit comprising a light emitting device (ED, a first pixel circuit 1540, and a second pixel circuit 1550 connected thereto. The first pixel circuit 1540 may be a high-voltage driving circuit, and the second pixel circuit 1550 may be a low-voltage driving circuit. The second pixel circuit 1550 may be implemented by a plurality of logic circuits.

The light emitting device (ED) may be selectively turned on during each sub-frame based on the bit value (logic level) of image data provided from a data driver 1500 during one frame. Accordingly, the light emission time is adjusted within the frame to express grayscale levels. The first pixel circuit 1540 may control the light emission and non-emission of the light emitting device (ED) in response to control signals applied during each of the plurality of sub-frames within a frame. The control signal may be a pulse width modulation (PWM) signal.

The first pixel circuit 1540 may include a first transistor 1541, a second transistor 1545, and a level shifter 1543, all electrically connected to a current source 1500. The first transistor 1541 may output a driving current. The gate of the first transistor 1541 may be connected to the current source 1500, the first terminal may be connected to a power supply voltage (VDD), and the second terminal may be connected to the first terminal of the second transistor 1545.

The gate of the first transistor 1541 may be connected to the gate of a first transistor 51 of the current source 1500, forming a current mirror circuit. Accordingly, when the first transistor 51 of the current source 1500 is turned on, the first transistor 1541 may output a driving current corresponding to a current (Iref) generated in the current source 1500. In this case, the driving current may be equal to the current Iref) flowing through the current source 1500.

The second transistor 1545 may supply or block a driving current to the light emitting element (ED) according to a PWM signal. The second transistor 1545 may have a gate connected to an output terminal of the level shifter 1543, a first terminal connected to a second terminal of the first transistor 1541, and a second terminal connected to the light emitting element (ED).

The second transistor 1545 may be turned on or off based on a voltage output from the level shifter 1543. A light emission time of the light emitting element (ED) may be controlled based on a turn-on or turn-off time of the second transistor 1545. When a gate-on level signal (which is a low level signal in the embodiment of FIG. 15) is applied to the gate of the second transistor 1545, the second transistor 1545 may be turned on to deliver a driving current (Iref) output from the first transistor 1541 to the light emitting element (ED) so that the light emitting element (ED) emits light.

Conversely, when a gate-off level signal (which is a high level signal in the embodiment of FIG. 15) is applied to the gate of the second transistor 1545, the second transistor 1545 may be turned off to block delivery of the driving current (Iref) output from the first transistor 1541 to the light emitting element (ED), so that the light emitting element (ED) does not emit light. A light emission time and a non-light emission time of the light emitting element (ED) during one frame may be controlled based on the turn-on and turn-off times of the second transistor 1545, and a color depth of a pixel unit 110 may be represented.

The level shifter 1543 may be connected to an output terminal of a PWM controller 1551 of the second pixel circuit 1550, and may convert a voltage level of a first PWM signal output from the PWM controller 1551 to generate a second PWM signal. The level shifter 1543 may generate the second PWM signal by converting the first PWM signal into a gate-on level signal that can turn on the second transistor 1545 and a gate-off level signal that can turn off the second transistor 1545.

A pulse voltage level of the second PWM signal output from the level shifter 1543 may be higher than that of the first PWM signal, and the level shifter 1543 may include a boosting circuit for boosting an input voltage. In addition, the level shifter 1543 may be implemented using a plurality of transistors.

A turn-on time and a turn-off time of the second transistor 1545 during one frame may be determined based on a pulse width of the first PWM signal. The second pixel circuit 1550 may store image data provided from the data driver 1500 during a data writing period in each frame and may generate the first PWM signal based on a bit value and a clock signal during a light emission period.

The second pixel circuit 1550 may include a PWM controller 1551 and a memory 1553. The PWM controller 1551 may generate a first PWM signal based on a clock signal (CK) input from a clock generator 120 during a light emission period and a bit value of image data read from the memory 1553.

When a clock signal in subframe units is input from the clock generator 120, the PWM controller 1551 may read a corresponding image data bit value from the memory 1553 and generate the first PWM signal. The PWM controller 1551 may control a pulse width of the first PWM signal based on the bit value of the image data in subframe units and the pulse width of the clock signal. For example, when the bit value of the image data is 1, a pulse of the PWM signal may be turned on for the pulse width of the clock signal, and when the bit value is 0, the pulse of the PWM signal may be turned off for the pulse width of the clock signal.

That is, the on-time and off-time of the PWM signal pulse output may be determined by the pulse width (signal length) of the clock signal. The PWM controller 1551 may include a logic circuit (e.g., an OR gate circuit) implemented using one or more transistors.

The memory 1553 may store image data provided from the data driver 1500 during a data writing period in synchronization with a frame start signal. In the case of a still image, the data previously stored in the memory 1553 may be used for displaying images over multiple frames until the image is updated or refreshed.

The memory 1553 may store one or more bits of data and, in one embodiment, may be implemented as an n-bit memory. Alternatively, depending on the driving frequency, the memory may be implemented as a memory storing less than n bits and may be configured using one or more transistors.

FIG. 17 is a diagram illustrating another example of a display system according to an embodiment.

Referring to FIG. 17, the display system includes a host 1710, a display driver IC 1720, and a display panel 1730 of an in-pixel memory type. Each pixel included in the display panel 1730 may include an embedded memory 1731 capable of storing digital data internally.

The display driver IC 1720 and the in-pixel memory type display panel 1730 may collectively be referred to as a display module 1740.

The display driver IC 1720 and the display panel 1730 may each have the same configuration as the display driver IC 220 and the display panel 230 shown in FIG. 2.

The host 1710 may include an application processor (AP) 1711, an AP buffer 1713, and a display controller 1715.

The AP 1711 may perform image processing such as image data generation and rendering, and may configure image data on a frame basis and store it in the AP buffer 1713. The image data may also be referred to as “display data.”

The display controller 1715 may read the stored frame data from the AP buffer 1713 and generate synchronization signals such as Hsync and Vsync. In other words, the display controller 1715 may generate synchronization signals to output the display data generated by the AP 1711 on a frame basis. The display controller 1715 may transmit the frame data and synchronization signals to the display module 1740. At this time, the display module 1740 may receive the frame data and synchronization signals from the display controller 1715. The display module 1740 may output the display data based on the frame data and synchronization signals.

The display controller 1715 may determine whether the frame data is updated and may generate a control command based on whether the frame data has been updated. The control command according to the update status may be transmitted to the display module 1740. For example, the control command according to the update status may be a PSR (Panel Self Refresh) command.

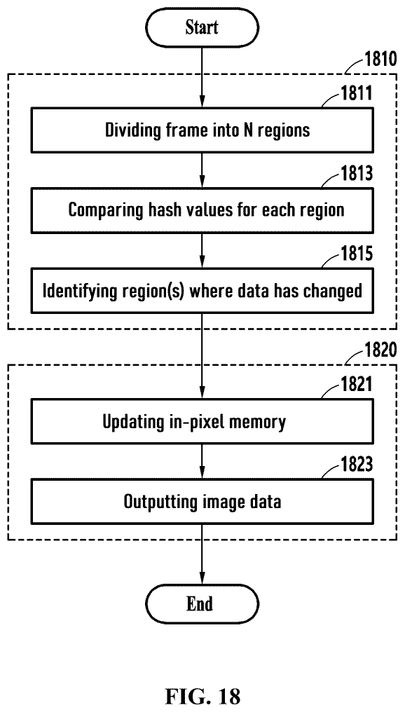

FIG. 18 is a flowchart illustrating another example of a display control method according to one embodiment.

The method illustrated in FIG. 18 may be performed by the display system shown in FIG. 2, FIG. 3, or FIG. 17.

Referring to FIG. 18, in step 1810, the display system determines whether any portion of the entire frame data has changed, and in step 1820, refreshes the screen based on image data of the changed region and location information corresponding to that region.

For example, the display controller of the host may divide the entire frame data into predetermined partial regions and determine whether each partial region has changed. In addition, the display module may refresh the screen based on the image data of the changed region and the location information for the changed region.

When detecting whether data has changed in units of partial regions rather than the entire frame, it is possible to distinguish between frequently changing regions and static regions. Accordingly, only specific regions of interest such as subtitle areas or indicator regions may be updated. Since only the changed image data is transmitted from the host to the display module, the amount of data transmission and power consumption can be reduced. Furthermore, the overall system complexity can be reduced and processing speed improved.

Step 1810 may include dividing one frame into N regions (step 1811).

The N regions may be defined as groups of consecutive rows within a frame, or as multiple regions of identical size.

Step 1810 may include extracting hash values for each of the N regions and comparing them with the hash values of the corresponding N regions of the previous frame (step 1813).

Based on the comparison, operation 1810 may further include identifying a region (Pn) among the N regions where data has changed.

The hash values for the N regions may be stored in the buffer memory of the host. For example, the hash values for the N regions of the previous frame F(t) may be stored in the buffer memory. After completing the comparison, the hash values for the previous frame F(t) may be deleted, and the hash values for the N regions of the current frame F(t+1) may be stored in the buffer memory.

The image data and location information of the region (Pn) where data has changed among the N regions may be transmitted from the host to the display module. The location information may take the form of a number, identifier, or timing signal indicating the region in which data has changed within the entire frame.

Step 1820 may include a “pixel memory update step (1821)” in which image data for the region (Pn) where data has changed is written to the in-pixel memory, while the image data stored in the in-pixel memory for the remaining regions maintains the previous frame data.

Step 1820 may further include scanning the data stored in the in-pixel memory to output image data for display.

The size and arrangement of N regions may be dynamically adjusted based on displayed content or historical change patterns. For example, smaller regions may be used in areas with frequent updates and larger regions in areas that typically remain static.

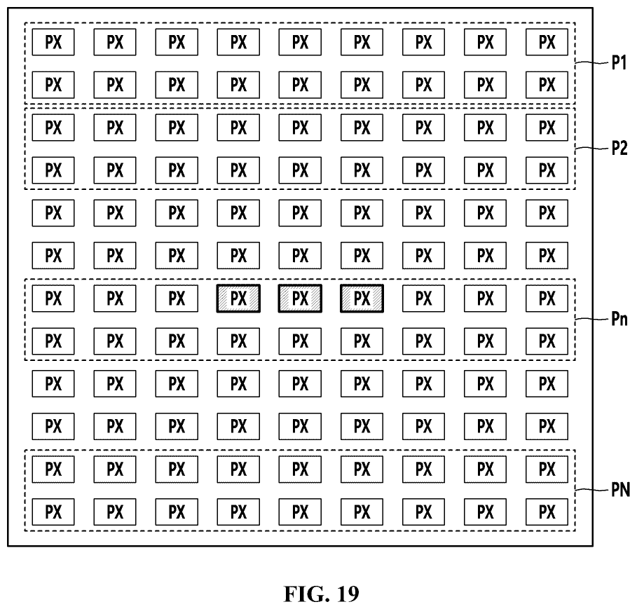

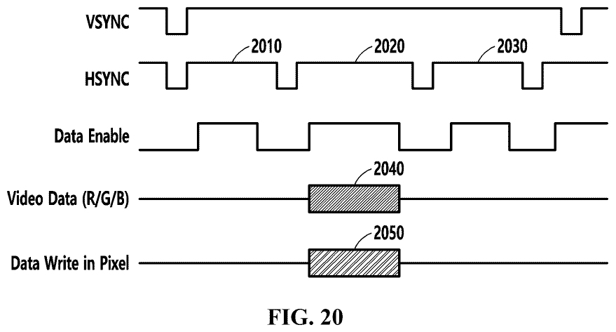

FIGS. 19 and 20 are diagrams illustrating a further example of a frame data comparison method according to one embodiment.

FIGS. 19 and 20 illustrate an example in which one frame is divided into N regions based on Hsync periods.

To divide one frame into N regions using Hsync intervals as unit divisions, the frame may be partitioned into regions defined as groups of consecutive rows.

The example illustrated in FIG. 19 shows a case in which two consecutive Hsync periods are grouped as one region. Accordingly, one frame is divided into a plurality of regions P1, P2, . . . Pn . . . PN.

In this example, Pn in FIG. 19 corresponds to a region where data has changed, since three pixel values (PX indicated by hatching in FIG. 19) have changed. In this case, the hash value [F(t)_Pn_hash] for the Pn region of the previous frame F(t) differs from the hash value [F(t+1)_Pn_hash] for the Pn region of the current frame F(t+1).

Referring to FIG. 20, during the active periods (2010, 2020, 2030) of the Hsync signal for one frame, only the video data (R/G/B) (2040) corresponding to pixels included in Pn may be transmitted from the host to the display module.

The display module may write the image data into the in-pixel memory during a period (2050) in which the Data Enable (DE) signal is active and image data is supplied.

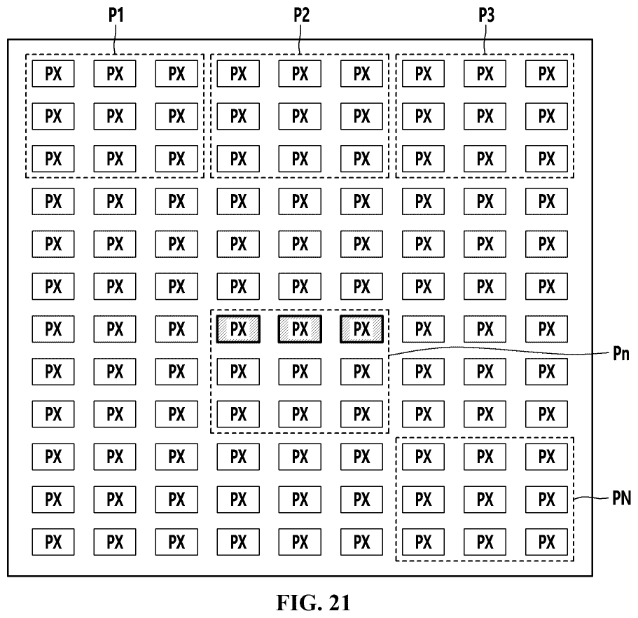

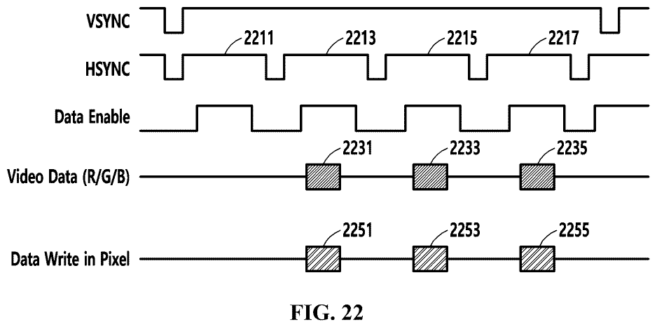

FIGS. 21 and 22 are diagrams illustrating a further example of a frame data comparison method according to one embodiment.

FIGS. 21 and 22 illustrate an example in which one frame is divided into N regions of equal size.

The example illustrated in FIG. 21 shows an example in which each region has a size of 3×3 pixels, and shows a case in which the same pixels as in FIG. 19 have changed.

Referring to FIG. 22, during the active periods (2211, 2213, 2215, 2217) of the Hsync signal, only the video data (R/G/B) (2231, 2233, 2235) corresponding to the nine pixels included in Pn may be transmitted from the host to the display module.

Since Pn illustrated in FIG. 22 includes three rows, video data is transmitted during each of the three active periods (2213, 2215, 2217) of the Hsync signal.

The display module may write the image data into the in-pixel memory during the periods (2251, 2253, 2255) in which the Data Enable (DE) signal is active and image data is supplied.

This region-based partial-update technique can be used together with the frame-level or synchronization-signal-based methods described with reference to FIGS. 6-18.

For example, when no changed regions are identified, the host or the display driver IC (DDIC) may use a Panel Self Refresh (PSR) command (e.g., via an Embedded DisplayPort (eDP)) to maintain the display state without transmitting new frame data.

When some regions have changed, only the data of those regions may be transmitted together with timing signals (e.g., vertical synchronization (Vsync), horizontal synchronization (Hsync), and data-enable (DE) windows) indicating the update locations.

The above-described devices, such as the comparator, interface controller, logic controller, and display controller, may be implemented using hardware components, software components, or a combination of hardware and software components. For example, the devices and components described in the embodiments may be implemented using one or more general-purpose or special-purpose computers, such as a processor, controller, arithmetic logic unit (ALU), digital signal processor (DSP), microcomputer, field programmable array (FPA), programmable logic unit (PLU), microprocessor, or any other device capable of executing and responding to instructions.

The processing device may execute an operating system (OS) and one or more software applications running on the operating system. The processing device may also access, store, manipulate, process, and generate data in response to the execution of software. For convenience of explanation, the processing device may be described as a single unit, but one of ordinary skill in the art will understand that the processing device may include multiple processing elements and/or different types of processing elements.

For example, the processing device may include multiple processors or a processor and a controller. Other processing configurations, such as parallel processors, may also be used.

The software may include a computer program, code, instructions, or any combination thereof, and may configure the processing device to operate in a desired manner or direct the processing device independently or collectively. The software and/or data may be embodied permanently or temporarily in any type of machine, component, physical device, virtual equipment, computer-readable medium or device, or transmitted signal wave for interpretation or execution by the processing device or for providing instructions or data to the processing device. The software may be distributed across computer systems connected over a network and may be stored or executed in a distributed manner. The software and data may be stored on one or more computer-readable recording media.

The methods according to the embodiments may be implemented as program instructions executable through various computer means and may be recorded in a computer-readable medium. The computer-readable medium may include program instructions, data files, data structures, or a combination thereof. The program instructions recorded on the medium may include those specially designed and configured for the embodiments or those known and available to a person skilled in the art of computer software.

Examples of the computer-readable recording medium include magnetic media such as hard disks, floppy disks, and magnetic tapes; optical media such as CD-ROMs and DVDs; magneto-optical media such as floptical disks; and hardware devices specifically configured to store and execute program instructions, such as ROM, RAM, and flash memory. The program instructions may include machine language code such as that generated by a compiler, as well as high-level language code that may be executed by a computer using an interpreter or the like. The above-described hardware devices may be configured to operate as one or more software modules for performing the operations of the embodiments, and vice versa.

Although the embodiments have been described above with reference to limited figures, various modifications and alterations may be made based on the above disclosure by those skilled in the art. For example, the described technologies may be performed in a different order than described, and/or the components of the described systems, structures, devices, and circuits may be combined or arranged in a different form, or replaced or substituted with other components or equivalents, while still achieving appropriate results.

Accordingly, other implementations, other embodiments, and equivalents to the claims below are all within the scope of the appended claims.

1. A display control method of a host device, the method comprising:
generating display data;
generating a synchronization signal for outputting the display data on a frame-by-frame basis;
determining whether current frame data is identical to previous frame data for the frame data generated on a frame-by-frame basis; and
transmitting, when the current frame data is identical to the previous frame data, a command indicating no change in frame data to a display module.

2. The method of claim 1, wherein the command is a Panel Self Refresh (PSR) command.

3. The method of claim 1, wherein the command is transmitted via an Embedded DisplayPort (eDP) protocol.

4. The method of claim 1, wherein each pixel of the display module includes an in-pixel memory.

5. The method of claim 1, wherein the host device determines whether the frame data has changed by comparing one or more of a hash value, a checksum, metadata, and a Cyclic Redundancy Check (CRC) value of the previous frame data and the current frame data.

6. A display control method of a host device, the method comprising:
generating display data;
generating a synchronization signal for outputting the display data on a frame-by-frame basis;
determining whether current frame data is identical to previous frame data for the frame data generated on a frame-by-frame basis; and
transmitting, when the current frame data is identical to the previous frame data, the synchronization signal excluding the frame data to a display module.

7. The method of claim 6, wherein:
the synchronization signal includes a vertical synchronization signal (Vsync) and a horizontal synchronization signal (Hsync); and
the display module adjusts timing of an internal synchronization signal based on the synchronization signal received from the host device.

8. A display system comprising:
an application processor (AP) configured to generate display data;
a buffer memory configured to store the display data; and
a display controller configured to generate a synchronization signal for outputting the display data on a frame-by-frame basis,
wherein, when currently generated frame data is identical to previous frame data stored in the buffer memory, the display controller generates and transmits a command indicating no change in the frame data to a display module.

9. The display system of claim 8, further comprising:
a display module configured to receive at least one of the frame data and the synchronization signal from the display controller and output the display data.

10. The display system of claim 9, wherein:
the display module includes a display panel comprises a plurality of pixels, each pixel comprises an in-pixel memory configured to store, in multiple bits, pixel values of frame data corresponding to the respective pixel, and
the display module does not require a frame memory configured to store the frame data.
